(19) United States
(12) Patent Application Publication
(10) Pub. No.: US 2020/0267255 A1
(43) Pub. Date: Aug. 20, 2020

(54) FAULT ANALYSIS DEVICE

(71) Applicant: BRITISH TELECOMMUNICATIONS PUBLIC LIMITED COMPANY, London (GB)

(72) Inventors: Richard GEDGE, London (GB); Ian NEILD, London (GB)

(21) Appl. No.: 16/651,549

(22) PCT Filed: Aug. 21, 2018
(86) PCT No.: PCT/EP2018/072575

§ 371 Date: Mar. 27, 2020

(30) Foreign Application Priority Data
Sep. 27, 2017 (EP) 17193480.5

(51) Int. Cl. H04M 3/30

(52) U.S. Cl. CPC H04M 3/304; H04M 3/301

(57) ABSTRACT

This invention relates to a fault analysis device that can be connected to a DSL line and home modem, and used to perform line measurements when interference may be present. The device receives status information about the DSL line from the modem via a suitable interface such as Ethernet, and when the status information indicates that the line is not synchronised, which may be due to interference causing the line to lose synchronisation, the device disconnects the line from the modem and performs spectral analysis on the line. In doing so, measurements are made at the time when interference may be occurring, rather than at some later time when interference may no longer be present.

### FIELD OF THE INVENTION

This invention relates to a fault analysis device for a digital subscriber line.

### BACKGROUND TO THE INVENTION

Digital subscriber line (DSL) services, commonly referred to as “broadband” services, are deployed using metallic PSTN lines that run between a digital subscriber line access multiplexer (DSLAM) and modems in subscribers' properties. With asymmetric DSL (ADSL) the DSLAM is located in the exchange and the line can be typically up to 7 km in length. With very-high bit-rate DSL (VDSL), the DSLAM is located in a local cabinet with the line being much shorter, typically a maximum of 2 km. The line is normally made up of a twisted copper pair, but can include lengths of aluminium.

Faults on DSL lines are not uncommon, and currently most faults are found by customers reporting problems such as their line being noisy, having slower than expected broadband speed, or even interrupted broadband service. Troubleshooting a fault often includes performing line tests on the line. Line tests can also be performed proactively to identify faults before a customer reports them. These line tests are typically electrical line tests that measure the electrical characteristics of a line and check that the results meet a standard (for example, as set out in SIN349 by British Telecommunications plc). It is also possible to compare line tests over a period of time to see if the line's electrical characteristics are deteriorating. Once a fault has been detected, an engineer can use electrical line testing, typically pair quality tests, to try and determine where the fault is located and make the appropriate repairs.

However, there are a range of fault conditions which are not picked up by this process. This can be due to the faults being intermittent or not severe enough to be measureable using existing techniques. Intermittent faults are particularly problematic to find but can cause great disruption to broadband services where a line drop can result in a service outage whilst the line retrains.

DSL services use a spectral band that is shared with other transmissions. The usage of electro-mechanical, electronic, and electrical equipment can also generate radio frequency signals in the same spectral band, although under normal operation these signals are of a sufficiently low level as to cause no interference with broadband. However, under fault conditions or substandard installation such equipment can generate electromagnetic (radio frequency) signals that can interfere with and significantly affect the performance of DSL broadband. Such electromagnetic interference is often referred to a Repetitive Electrical Impulse Noise (REIN) and Single High level Impulse Noise Event (SHINE). PSTN lines that are electrically unbalanced are also more susceptible to interference.

When such interference occurs it can be extremely difficult and time consuming to first detect the interference is present and causing a problem, and secondly to find the source of the interference. This is compounded by the REIN/SHINE being present for short periods of time at seemingly random times during the day making the detection by sending an engineer to visit very problematic.

U.S. Pat. No. 7,200,206 describes a method and apparatus for testing and isolating the cause of a service failure. A network interface device is positioned between a subscriber loop and the internal wiring of a subscriber's premise. Operational and performance data is captured and stored in memory for later use and analysis. Commands issued to the network interface device selectively loop-back transmitted data at either the network or subscriber side of the network interface device and/or selectively engage or disengage one or more of the addressed subscriber and premise loops.

EP 1693985 describes a remote terminal subscriber access control module added at the subscriber line between a remote terminal unit (RTU) and a broadband line testing control module. In this way, when the broadband testing control module starts to implement subscriber line testing, remote controlling RTU to automatically disconnect from the subscriber line can be realized through remotely controlling the switch status of the remote terminal subscriber access control module, and automatic connection between the RTU and the subscriber line can be restored after completion of subscriber line testing.

### SUMMARY OF THE INVENTION

According to one aspect of the present invention, there is provided a fault analysis device comprising:

a first interface for connection to a digital subscriber line to an access network side;
a second interface for connection to a digital subscriber line to a home modem side;
a spectral analysis module;
a switch operable in a first mode or a second mode, wherein the first mode connects the first interface to the second interface, and wherein the second mode disconnects the first interface from the second interface and connects the first interface to the spectral analysis module;
a controller configured to detect when a digital subscriber line connected to the second interface has lost synchronisation, and in response,
to toggle the switch from the first mode to the second mode, then
to perform spectral analysis measurements using the spectral analysis module on the digital subscriber line to the access network side when the line does not have synchronisation, and then
to toggle the switch from the second mode to the first mode.

The fault analysis device may comprise a third interface to the home modem adapted to receive status information from the home modem, and wherein the controller is adapted to use the received status information to detect when a digital subscriber line connected to the second interface has lost synchronisation.

The spectral analysis measurements may be power spectral density measurements.

The analysis module may be comprised of a software defined radio.

This invention describes a device and method for diagnosing problematic xDSL lines that suffer from noise ingress. The invention can also be used to fault find other line problems, particularly those that are intermittent. It can be easily deployed by the customer, and installed in-line into an existing DSL set-up by simply unplugging the DSL from the home modem, and plugging it into the fault analysis device, and connecting the fault analysis device to the modem.

The device activates to perform spectral analysis on the line at a time when interference might be present. It does so when the line is silent and does not have synchronisation, and as such does not significantly add to the interruption in service that is already occurring.

### BRIEF DESCRIPTION OF THE DRAWINGS

For a better understanding of the present invention reference will now be made by way of example only to the accompanying drawings, in which:

FIG. 1 is a system diagram showing a DSL network with DSL lines running to customer premises, including the fault analysis device in an example of the invention;

FIG. 2 is a schematic of a fault analysis device in an example of the invention;

FIG. 3 is an example matching network (BALUN);

FIG. 4 is a block diagram of a software defined radio in an example of the invention;

FIG. 5 is a flow chart summarising the operation of the fault analysis device in an example of the invention;

FIG. 6 is a power spectrum density plot of a normal PSTN line.

FIG. 7 is a power spectrum density plot of the same line but with interference present.

### DESCRIPTION OF PREFERRED EMBODIMENTS

The present invention is described herein with reference to particular examples. The invention is not, however, limited to such examples.

This invention relates to a fault analysis device that can be connected to a DSL line and home modem, and used to perform line measurements when interference may be present. The device receives status information about the DSL line from the modem via a suitable interface such as Ethernet, and when the status information indicates that the line is not synchronised, which may be due to interference causing the line to lose synchronisation, the device disconnects the line from the modem and performs spectral analysis on the line. In doing so, measurements are made at the time when interference may be occurring, rather than at some later time when interference may no longer be present.

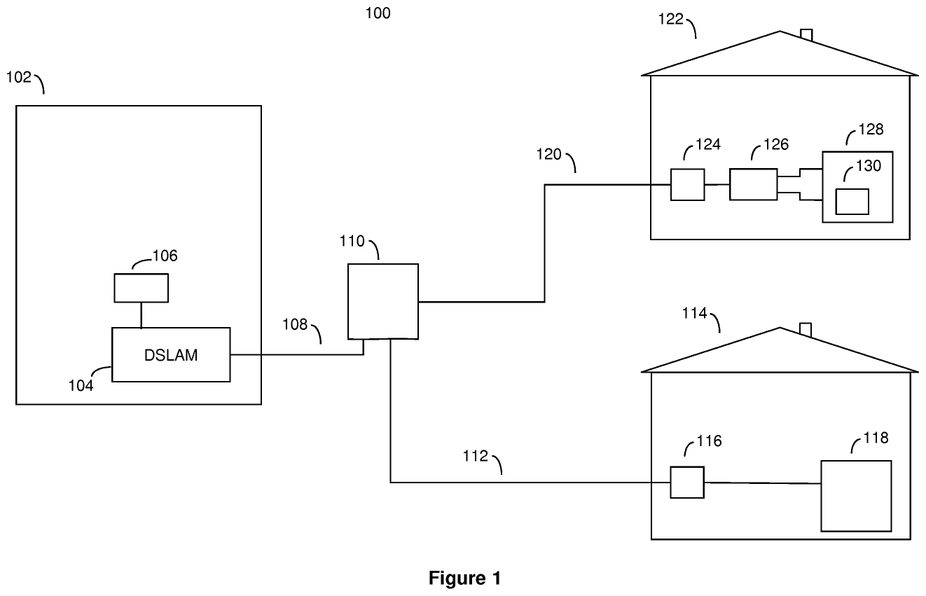

FIG. 1 illustrates a simplified overview diagram of an asymmetric digital subscriber line (ADSL) network. Some elements have been omitted for simplicity, and conversely in some practical deployments, some elements shown are not required. Similarly, some elements described as being overhead may be underground.

The telecommunications network 100 includes an exchange building 102 housing a digital subscriber line access multiplexer DSLAM 104 and line test equipment 106. The DSLAM provides digital subscriber line (DSL) services to connected lines and associated customer premises. The connected lines are thus also referred to as digital subscriber lines, or DSL lines, though it will be appreciated that the lines can also provide PSTN services. The lines are normally comprised of a twisted metallic pair, such as copper or aluminium.

A multi-pair cable 108 (comprising multiple lines) connects the DSLAM 104 to a Primary Cross Connection Point (PCP) 110. From the PCP 110 DSL line 112 extends to a customer premises 114, and specifically a Network Terminating Equipment NTE 116, which in turn is connected to a DSL modem or hub 118 via internal wiring.

In an example of the invention, another line, DSL line 120 connects from the PCP 110 to customer premise 122, and specifically Network Terminating Equipment NTE 124. A fault analysis device 126 is connected in-line between the NTE 124 and a DSL modem or hub 128. As the fault analysis device 126 is lies physically between the NTE 124 and the modem 128, it intercepts the DSL line 120 before it connects to the modem 128. The fault analysis device 126 can be installed into existing home networks such as between the NTE 116 and modem 118.

The fault analysis device 126 also connects to the modem 128 via an Ethernet connection. In practice, this connection could be via Wi-Fi instead. The modem 128 includes an additional process 130 that provides an application programming interface (API). The API allows status information of the modem 128 and DSL line 120 to be interrogated by the fault analysis device 126. An appropriate API may already be provided by the modem 128, or additional software may need to be installed. As a minimum, the API should provide the line status of the DSL line 120, however, ideally those elements described by ITU spec. G997.1 would be available via the API.

For example the status of the line may be obtained by the API call-G997LineStatusGet. This returns a status code indicating the current status of the line: show-time (synced), silent, idle, handshake, full init. Show-time indicates the line is synchronised and operational.

In normal operation, electrical noise ingress on DSL lines causes the protocol to adapt in order to keep the line in synchronisation with the least transmission errors. However, in some instances, the interference is too severe and the DSL line protocol drops the connection and then restarts from scratch. This is called line resynchronisation.

This type of interference is often referred to a Repetitive Electrical Impulse Noise (REIN) and Single High level Impulse Noise Event (SHINE), and can result from faulty electro-mechanical, electronic, and electrical equipment generating electromagnetic signals in the same spectral band as used by the DSL line.

The fault analysis device 126 uses the API provided by the modem 130 to monitor the status of DSL line 120. When the modem 130 reports that the line 120 has dropped its DSL connection (status of modem not in show-time and is in silent), the fault analysis device 126 immediately electrically disconnects the DSL line 120 to the modem 130, and then carries out a spectral analysis of the DSL line 120 towards the exchange 102. After the spectral analysis is complete, the fault analysis device 126 reconnects the DSL line 120 to the modem 128, and the modem can continue its resynchronisation process.

The resulting spectral analysis results can be used to identify whether the line is experiencing REIN/SHINE interference. The impact of this process is to add a few seconds of additional time to the resynchronisation event. One important advantage of this approach is that the DSL line 120 is analysed at the time of disruption, and further is not service effecting to the customer as analysis is also during a line resynchronisation.

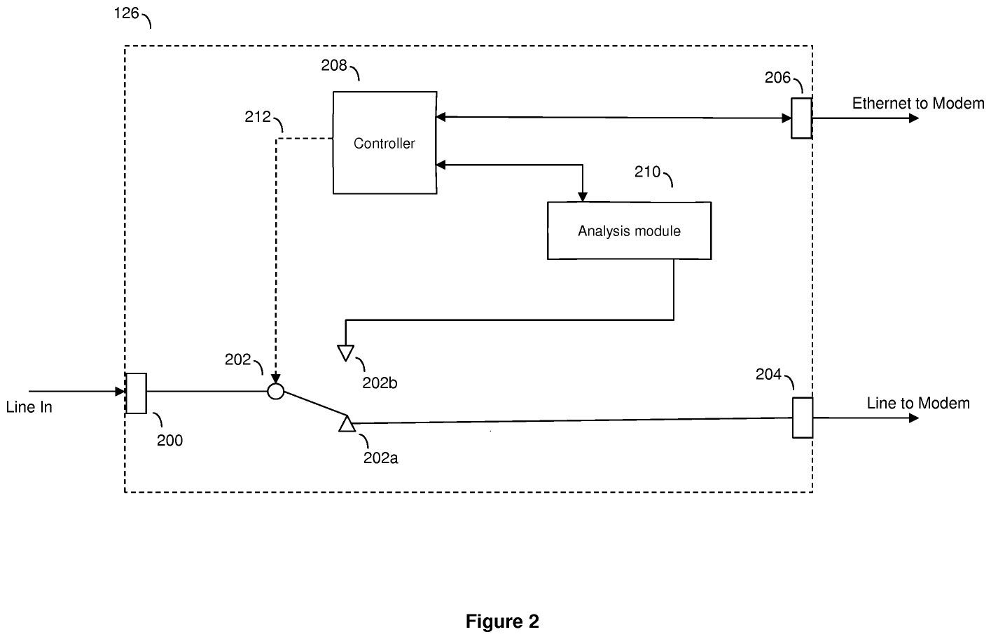

A more detailed schematic of the fault analysis device 126 is shown in FIG. 2.

The fault analysis device 126 comprises an input port 200, a switch 202, an output port 204, an Ethernet port 206, a controller 208, and an analysis module 210. The input port 200 connects an incoming DSL line 120 from the DSLAM 104 (exchange side) to the switch 202. The switch 202 has two positions 202a and 202b. In position 202a, the DSL line 120 is connected straight through from the switch 202 to the output port 204 and onto the modem 128. In position 202b, the DSL line 120 is connected to the analysis module 210. Under test conditions, status information from the modem 128 is obtained using an Ethernet connection with the modem 128 via the Ethernet port 206. The controller 208 processes the dependent on the received status information, the controller toggles the switch 202 between positions 202a (connecting the DSL line 120 to the output port 204) and 202b (connecting the DSL line 120 to the analysis module 210). The analysis module 210 is under direct control of the controller 208.

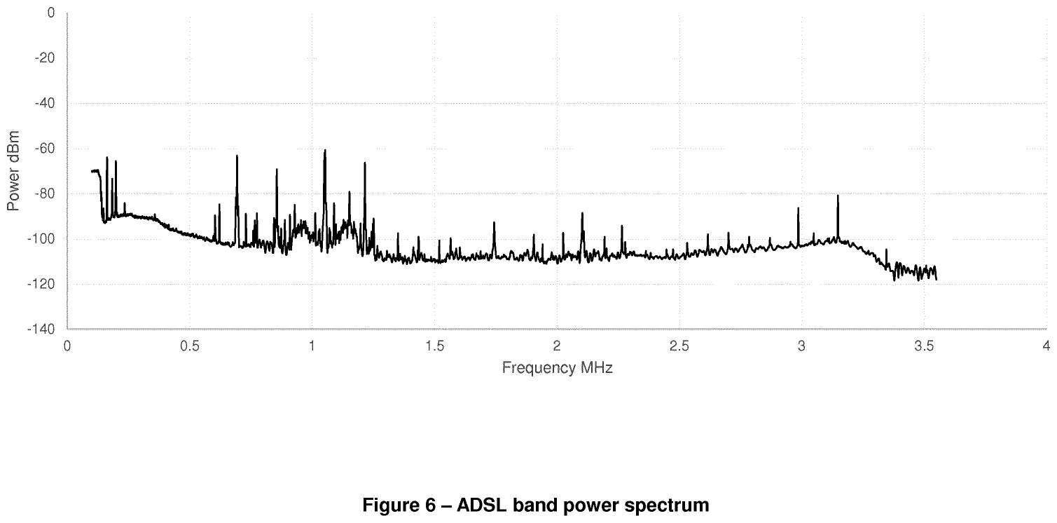

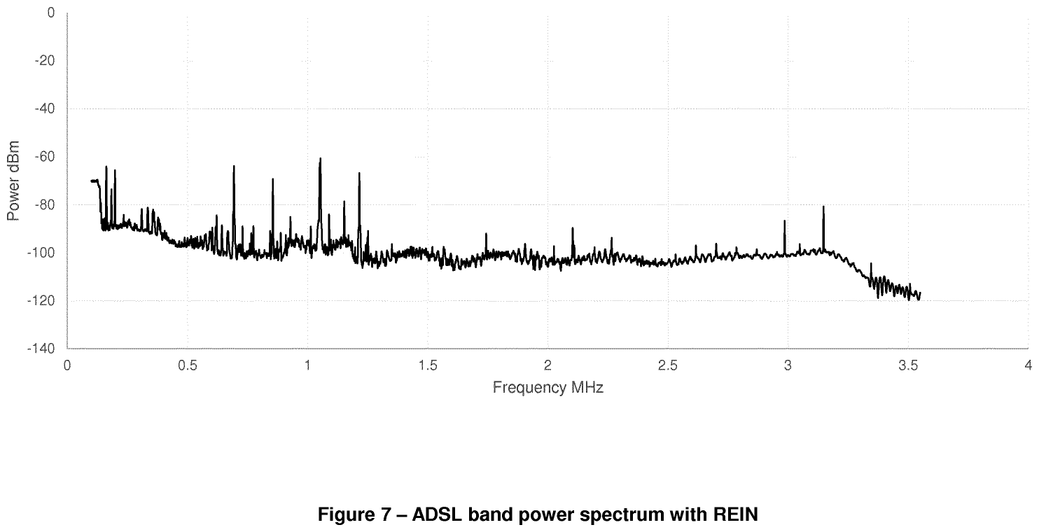

In one embodiment, the analysis module 210 is implemented as a Software Defined Radio (SDR). The SDR performs a power spectral density (PSD) measurement over the appropriate DSL frequency band used on this line. A number of measurements will be taken in order to build a temporal view but depending on the capability of the SDR this may take many seconds and therefore needs to be balanced against service downtime. An example of the power spectrum of a PSTN line for the ADSL band is shown in FIG. 6. This shows a normal line, the signals are mostly broadcast radio signals and there is also a background noise source between 0.75 MHz and 1.25 MHz. FIG. 7 shows the same line with a low level REIN interference signal. There are some clear signals shown at 0.4 MHz and also a general high frequency signal over the whole band. Although difficult to see visually in FIG. 7, signal processing techniques can be used to extract this signal, in this case it is odd harmonics indicating some form of digital switching, most likely a switched mode power supply. In practice many PSD's are captured over several seconds which provides a much clearer signal.

A skilled person will appreciate that a traditional hardware based spectrum analyser could be employed instead of an SDR.

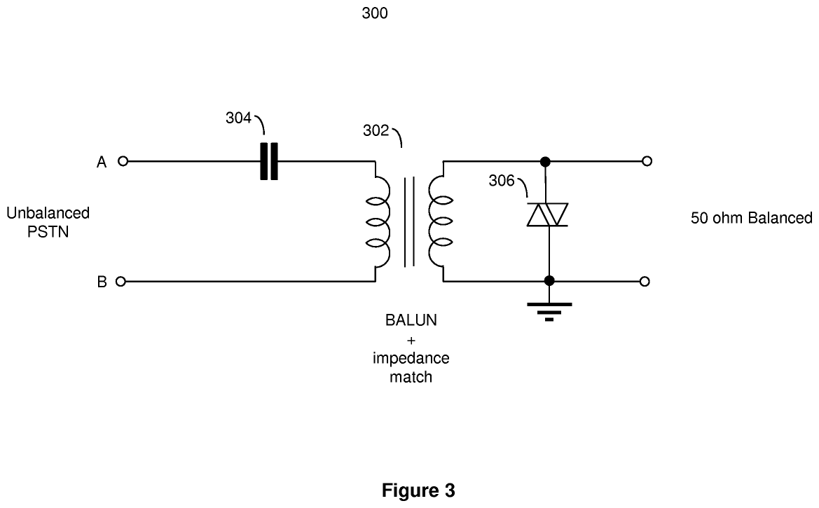

In order to optimally connect the SDR to the DSL line, a matching network is required. An example matching network is shown in FIG. 3, and is normally referred to as a BALUN (Balance to Unbalanced). The BALUN shown uses an isolation transformer, which matches the higher impedance of the DSL line to the SDR, and also uses a capacitor 304 to block the DC component. A protection device 306 is also employed in order to protect the SDR under high signal or fault conditions. A skilled person will appreciate that there are many other matching network variants that can be employed instead.

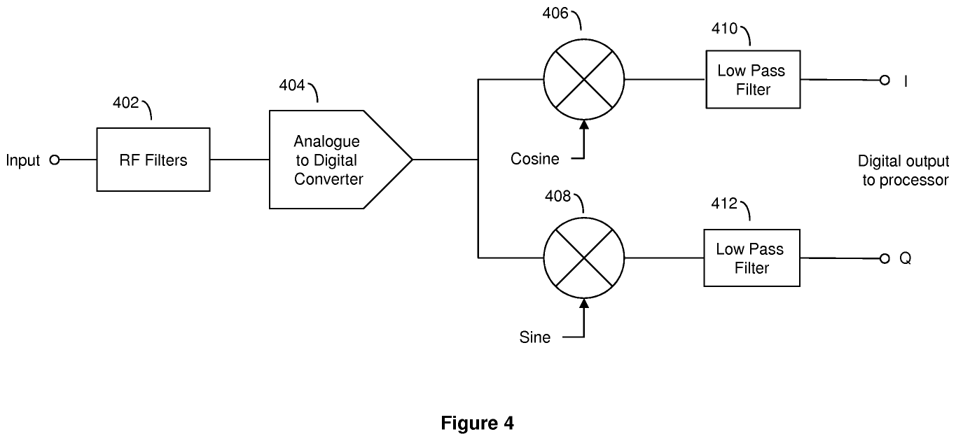

The SDR itself is a device which converts the radio spectrum received over the DSL line 120 into the digital domain. The specific spectral analysis and demodulation is done by software in the controller 208. An example of an SDR is shown in FIG. 4.

The input signal is provided by the DSL line 120 received over input port 200 of the fault analysis device 126. The input signal is usually band limited by the use of RF filters 402 before being digitised using an Analogue to Digital converter 404. The digitised signal is then mixed with a cosine signal 406 and sine signal 408 to provide an in phase (I) and quadrature (Q) signals respectively. Both signals are low pass filtered by low pass filters 410 and 412 in order to remove anomalous signals generated during the digitising and mixing processes. The resulting IQ signal is then output to the controller 208 for further digital signal processing.

The controller 208 configures the SDR to suit the RF frequency, bandwidth, and sampling rate to best allow the analysis it later undertakes. The resulting IQ signal from the SDR is then analysed by the controller 208 using DSP techniques. This software driven approach makes the overall operation and analysis totally flexible, and can be changed updating the software on the controller 208.

In a prototype, two SDR devices have been tested but others could be used. One based on the RTL2832U chipset, which is widely supported by the open source software. The other a radio spectrum processor RSP device has been used based on the Mirics MSI3101 chipset.

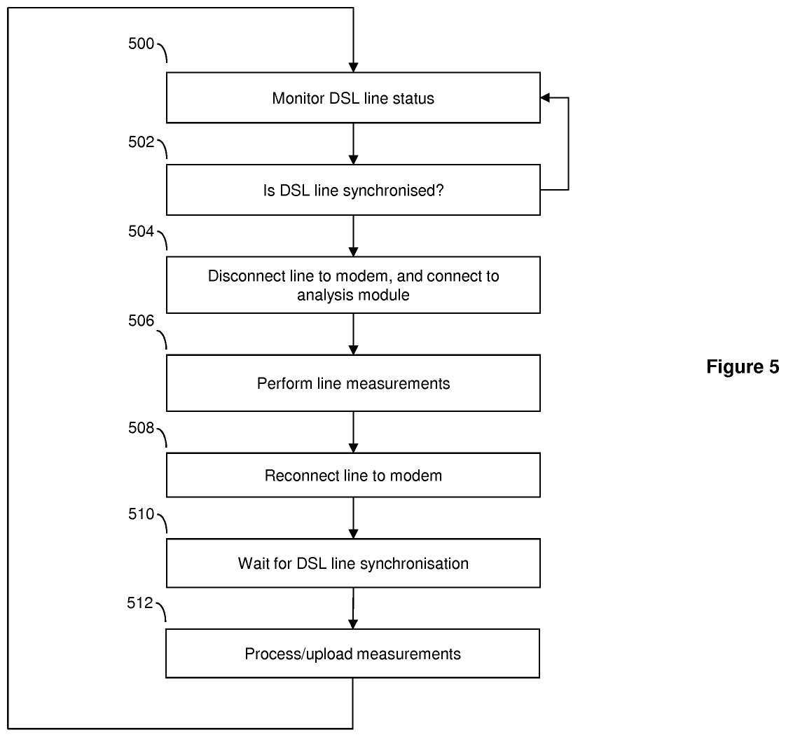

The operation of the fault analysis device 126 will now be described with reference to the flow chart of FIG. 5.

Processing starts with step 500. At step 500, the switch 202 is in position 202a, connecting the DSL line 120 from the input port 200 directly to the output port 204 and onto the modem 128. Meanwhile the controller 208 continuously monitors the status of the modem 128 and line 120 via the Ethernet port 206 using a suitable API call (see above).

In step 502, the controller 208 checks the status of the line to see if it is synchronised (in show-time). If the line is synchronised, then processing passes back to step 500, and the controller 208 continues to monitor the line status.

If the line is not synchronised and silent, then the modem 128 is about to start reinitialising, which may be as a result of interference. The controller 208 thus disconnects the line 120 from the modem 128, by toggling the switch 202 from position 202a (disconnecting the line from the modem 128) to position 202b and thus connecting the line 120 to the analysis module 210.

Then in step 506, the controller 208 controls the SDR in the analysis module 210 to performs line measurements, and preferably power spectral density (PSD) measurements over the appropriate DSL frequency band used on the line 120. The results are returned to the controller 208, which stores the results.

Once line measurements are complete, the controller 208 reconnects the modem 128 to the line 120 by toggling the switch 202 from position 202b to 202a.

In step 510, the controller 208 waits for the line 120 to complete resynchronisation, which it can do by monitoring the line status over the Ethernet connection and waiting for the status indicate synchronisation (in show-time). Then in step 512, the line measurements are uploaded into the network for analysis, or can be stored in memory in the fault detection module 126 for retrieval at some later time.

Processing then returns to step 500, where the line continues to be monitored by the controller 208.

The above examples have been described with reference to the DSL line 120 being switched over from connecting to the modem 128 to connecting to the analysis module 210. However, in alternative arrangements, the DSL line 120 is always connected to analysis module 210, with the switch operable to just disconnect the line 120 from the modem 128. This is important so that measurements can be taken by the analysis module when the line is quiet and not during resynchronisation, as the line is no longer connected to the modem 128 that will be attempting resynchronisation.

Exemplary embodiments of the invention are realised, at least in part, by executable computer program code which may be embodied in an application program data. When such computer program code is loaded into the memory of a processor in the controller 208, it provides a computer program code structure which is capable of performing at least part of the methods in accordance with the above described exemplary embodiments of the invention.

A person skilled in the art will appreciate that the computer program structure referred can correspond to the flow chart shown in FIG. 4 where each step of the flow chart can correspond to at least one line of computer program code and that such, in combination with the processor in the controller 208, provides apparatus for effecting the described process.

In general, it is noted herein that while the above describes examples of the invention, there are several variations and modifications which may be made to the described examples without departing from the scope of the present invention as defined in the appended claims. One skilled in the art will recognise modifications to the described examples.

1. A fault analysis device comprising:
a first interface for connection to a digital subscriber line to an access network side;
a second interface for connection to a digital subscriber line to a home modem side;
a spectral analysis module; characterised in that the device further comprises,
a switch operable in a first mode or a second mode, wherein the first mode connects the first interface to the second interface, and wherein the second mode disconnects the first interface from the second interface and connects the first interface to the spectral analysis module;
a controller configured to detect when a digital subscriber line connected to the second interface has lost synchronisation, and in response,
to toggle the switch from the first mode to the second mode, then
to perform spectral analysis measurements using the spectral analysis module on the digital subscriber line to the access network side when the line does not have synchronisation, and then
to toggle the switch from the second mode to the first mode.

2. A fault analysis device according to claim 1 comprising a third interface to the home modem adapted to receive status information from the home modem, and wherein the controller is adapted to use the received status information to detect when the digital subscriber line connected to the second interface has lost synchronisation.

3. A fault analysis device according to claim 1, wherein the spectral analysis measurements are power spectral density measurements.

4. A fault analysis device according to claim 1 wherein the spectral analysis module comprises a software defined radio.
